(19) United States
(12) Patent Application Publication
(10) Pub. No.: US 2019/0331267 A1
(43) Pub. Date: Oct. 31, 2019

(54) Fitting Device for Joining Pipes and Rods

(71) Applicant: Ridgway Holdings LLC, Ridgway, CO (US)

(72) Inventor: Robert Warren, Ridgway, CO (US)

(73) Assignee: Ridgway Holdings LLC, Ridgway, CO (US)

(21) Appl. No.: 16/396,218

(22) Filed: Apr. 26, 2019

Related U.S. Application Data
(60) Provisional application No. 62/663,361, filed on Apr. 27, 2018.

(51) Int. Cl. F16L 21/08; F16L 25/14; F16L 21/04; F16L 21/06; F16L 21/03

(52) U.S. Cl. CPC F16L 21/08; F16L 25/14; F16L 21/03; F16L 21/06; F16L 21/04

(57) ABSTRACT

A fitting device having one or more snap collars; and one or more lock collars, the lock collar having a sealing protrusion to seal the connection of the snap collar and lock collar on the pipe; the one or more snap collars being configured to be snapped in place over a pipe or pipes, and the lock collars being configured to be snapped in place over the pipe and the snap fittings, the sealing protrusion engaging the pipe to seal the connection of the snap collar and lock collar on the pipe so that a sealed joint will be formed.

### PRIORITY CLAIM

This application claims the priority benefit of U.S. Provisional Patent Application No. 62/663,361 filed Apr. 27, 2018 for “Fitting Device For Joining Pipes And Rods” of Robert Warren and Applicant, Ridgway Holdings, LLC, hereby incorporated herein by reference for all that is disclosed therein as though fully set forth here.

### BACKGROUND

A number of problems exist in plumbing and constructing with fittings for pipes or rods; generally all referred to herein as “pipes” herein.

One problem is that initially mating the fitting and pipe can be accomplished by thrusting or forcing the small female fitting over the long male end of the pipe along the longitudinal axis of the pipe. As the plumbing and constructing progresses, pipes and fittings become fixed within other building structures, and mating can only be accomplished by thrusting or forcing the longer and/or larger and/or more massive male pipe into the female fitting. This requires a movement along the pipe's longitudinal axis and presents significant challenges for the plumbing, construction, and repair process. Difficulties increase with diameter and rigidity of the pipe. These problems include, but are not limited to, increased cutting of the building structure and increased earth moving, both of which escalate costs and slow the process.

Another related problem is that for repair or modification of existing plumbing systems, access must be cut through finishes, dug up, or otherwise accessed. This increases the cost of the repair, and may result in damage to the structure and its surroundings which must then also be repaired.

Another problem is that in routing complex three-dimensional plumbing systems, and more generally constructing complex shapes using fittings with pipes, it is often advantageous to dry fit the pipes and fittings to test, and then refine both the lengths and orientations of pipes and orientation of the fittings in three dimensional space. To accomplish this, the pipes and fittings are often mated and unmated iteratively. Unfortunately, fittings often stick to pipes, and are often difficult to remove or twist for adjustment. The pipe must be iteratively moved along its longitudinal axis, which tends to exacerbate difficulties, escalate costs, and slow down the pipe fitting process.

Another problem is that in plumbing systems where a bonding agent is used, fittings can become fixed in an improper alignment. For example, when plumbing with PVC pipes and fittings, the bonding process requires that the user push, twist, and hold the pipes and/or fittings until the bond is established. In areas with limited access, and/or with complex arrangement of pipes, this can result in improper alignment of the pipe. To correct these alignment issues, parts may have to be cut out and replaced. This can introduce additional difficulties, escalate costs, and further slowdown the pipe fitting process.

Another problem is that for repair of conduit that contains a wire, fiber optic cable, or other type of strand, the repair must be accomplished without cutting the strand.

Another problem is repair of a pipe that contains a fluid or vacuum. The pipe cannot be cut without exacerbating the leakage and increasing flow outside the pipe further hampering the repair.

### BRIEF DESCRIPTION OF THE DRAWINGS

FIG. 1 is an isometric view of an example portion of a fitting device for joining pipes and rods.

FIG. 2 is an isometric view of an example discrete portion of a fitting device for joining pipes and rods.

FIG. 3 is an exploded isometric view of the combination fitting device for joining pipes and rods.

FIG. 4 is an isometric view of an example assembled combination fitting device for joining pipes and rods.

FIG. 5 is an exploded isometric view of an alternative fitting device for joining pipes and rods.

FIG. 6 is an isometric view of an example combination of snap fitting first parts of a fitting device for joining pipes and rods.

FIG. 7 is an isometric view of an example lock collar second part of a device for joining pipes and rods.

FIG. 8 is an isometric view of an example snap collar subsystem of a device for joining pipes and rods.

FIG. 9 is an isometric view of a close-up example snap collar subsystem showing details of example hook and nest and anti-thrust subsystems of a device for joining pipes and rods.

FIG. 10 is an exploded isometric view of an example fitting device for joining pipes and rods repairing a pipe with a fluid or vacuum inside.

FIG. 11 is an exploded isometric view of an alternative example snap fitting.

### DETAILED DESCRIPTION

A fitting device for joining pipes and rods is disclosed. In an example, the fitting device for joining pipes and rods is a general-purpose fitting for joining pipes, rods, or conduits. The fitting device may have application in the fields of plumbing or construction, but is not so limited. The example fitting device for joining pipes and rods can be implemented without needing movement of a fixed pipe, rod, conduit, or fitting (e.g., in the longitudinal direction) in order to assemble.

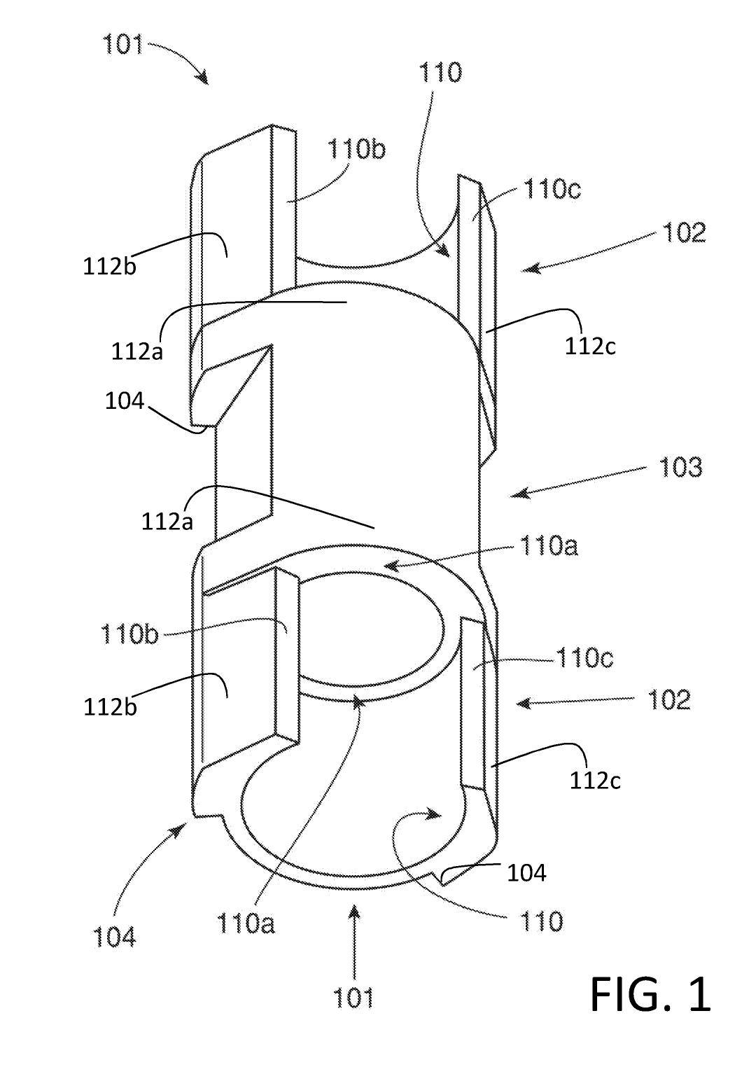

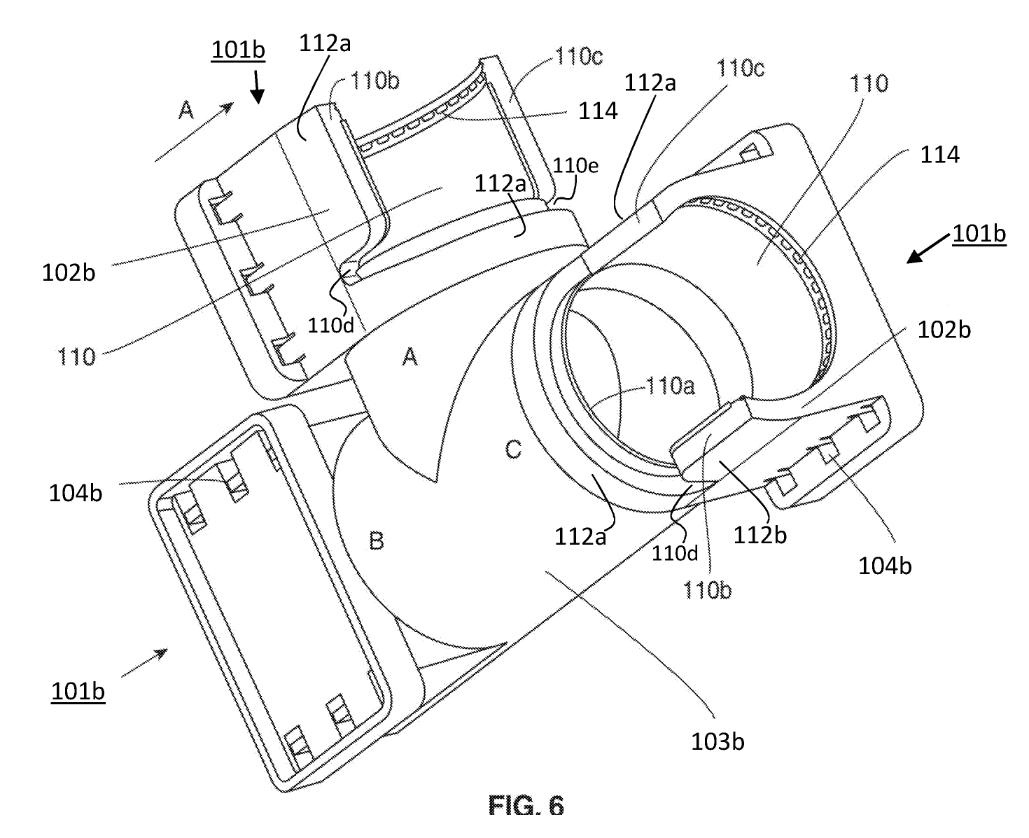

In an example, the fitting device for joining rods and pipes includes a snap portion and lock portion. The example snap portion of the overall fitting device is an individual component that includes one or more snap collar subsystems and can include (e.g., FIG. 1, below) or be connectable (e.g., FIG. 6, below) to a connecting architecture subsystem. A pipe, rod, or conduit is fitted into each snap collar subsystem thus joining the pipes in the geometry of the connecting architecture. The snap collar subsystem is substantially shaped as a hollow cylindrical arc sweeping out more than 180 degrees (but less than 360 degrees) such that it will have an open area in which a pipe may be disposed and snap over the cylindrical shape of the pipe by a motion perpendicular to the longitudinal axis of the pipe. Once snapped into place, the snap collar holds the pipe.

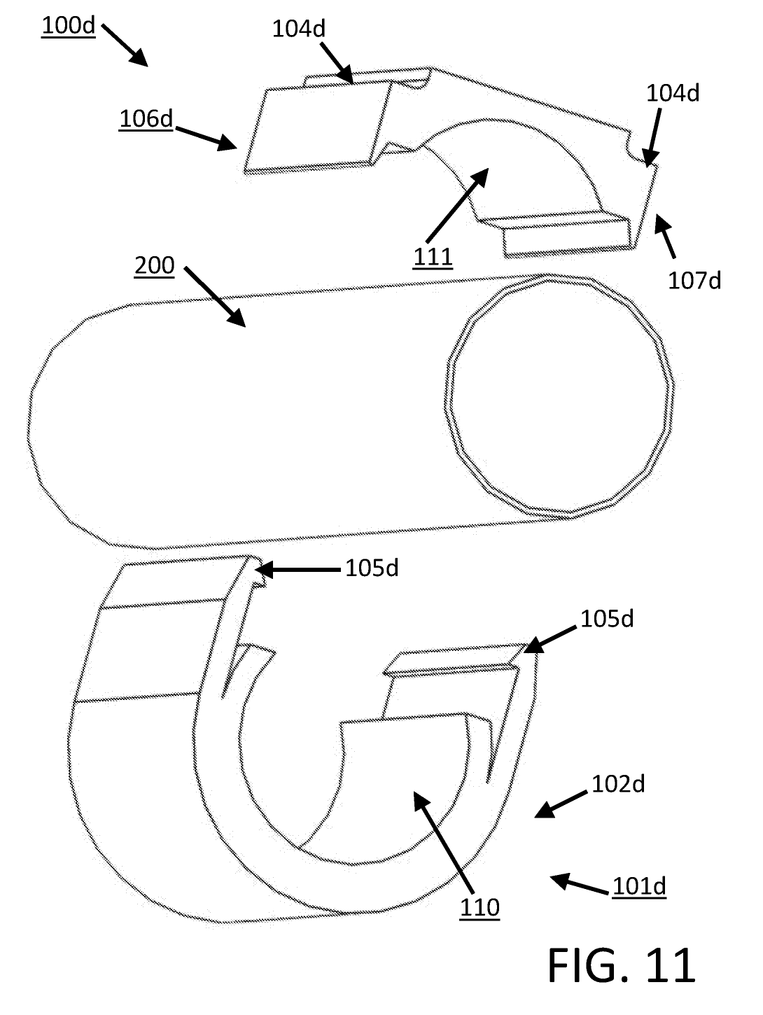

In an example, the lock collar is also substantially shaped as a hollow cylindrical arc sweeping out more than 180 degrees (but also less than 360 degrees), such that it will snap over the approximate cylindrical shape of the snap collar and pipe. As the lock collar snaps into place through a motion perpendicular to the longitudinal axis of the pipe, there are hooks (or nests, see FIG. 11, below) on the lock collar that fit into nests (or hooks, FIG. 11) on the snap collar, completing the fitting and mating of the overlapping and sealing surfaces.

In an example, the connecting architecture is a non-limiting configuration, e.g., any configuration and/or shape connection for practically connecting pipes or rods or like devices. Examples include, but are not limited to, a straight coupling, reducing fitting, elbow, tee, cross, adapter, street fitting, and others, making the fitting device for joining rods and pipes a general solution for joining pipes in any geometry.

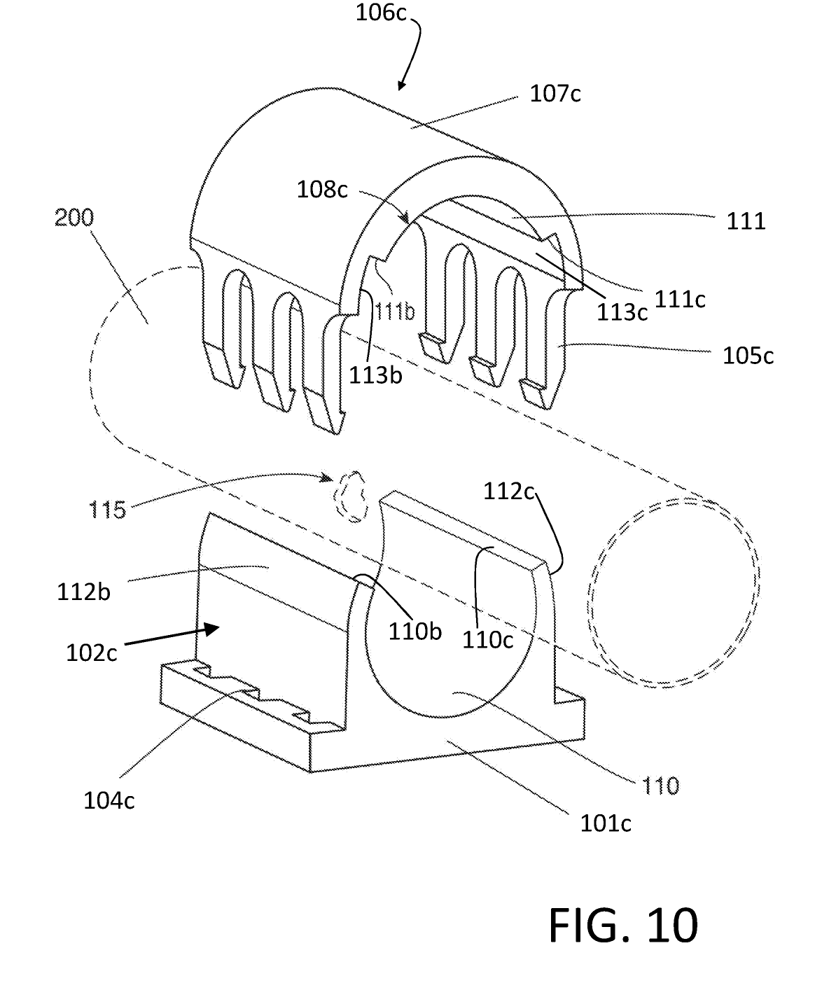

Note also that the discrete connecting architecture may not exist in some implementations. E.g., for repair or joining of conduit, or in an alternative where a strand may exist that cannot be cut, snap collars and lock collars may be employed without the connecting architecture, such that the two parts can be assembled around an existing conduit (see e.g., FIG. 10, below a repair without a strand) For repair of pipe or tubing, where a fluid or vacuum may exist causing a leak, a snap collar and lock collar may be employed without the connecting architecture, such that the two parts can be assembled around an existing pipe repairing the leak without cutting the pipe.

In an example, the large, overlapping three dimensional surfaces between the snap fitting portion, lock collar portion, and pipe, provide for a strong mechanical joint, a large surface area for glue, solder, or other bonding agents, and a three-dimensional surface that enables pressure-tight seals. The snap fitting and lock collar can generally be assembled without tools, creating a mechanically strong and rigid fitting that can be bonded using glue, solder or other appropriate bonding agent on the sealing surfaces. To facilitate a pressure tight seal without a bonding agent, the mating surfaces which are also referred to herein as sealing surfaces can be manufactured at close tolerances, and/or can be made of a softer seal material, and/or may be strongly forced together. This forcing may be accomplished by using an external, plier like tool to mate the lock collar to the snap collar and pipe.

The example fitting device for joining rods and pipes can be implemented as a general solution for joining pipes, without having to move the pipes in the lateral direction, thus avoiding associated complications and saving time. This solution can be applied to all pipes (threaded or unthreaded), using either a mechanical seal or a bonding agent or both, and it makes dry fitting complex systems of pipes simpler and easier than was previously possible. In an example, the device may also be used to maintain proper alignment of the fitting within a complex system of pipes, e.g., while a bonding agent is applied. In an example, the device can be implemented in construction or repair of virtually any practical application of shaped pipe fitting, or for the construction and repair of conduits that contain a wire or other strand.

Before continuing to description with the drawings in detail, it is noted that as used herein, the terms “includes” and “including” mean, but are not limited to, “includes” or “including” and “includes at least” or “including at least.” The term “based on” means “based on” and “based at least in part on.” The term “pipe” is meant to be interpreted broadly such that it includes not only pipes but also rods, conduits, and other objects of any material, with circular or other cross-section whose longitudinal dimension significantly exceeds their lateral dimensions.

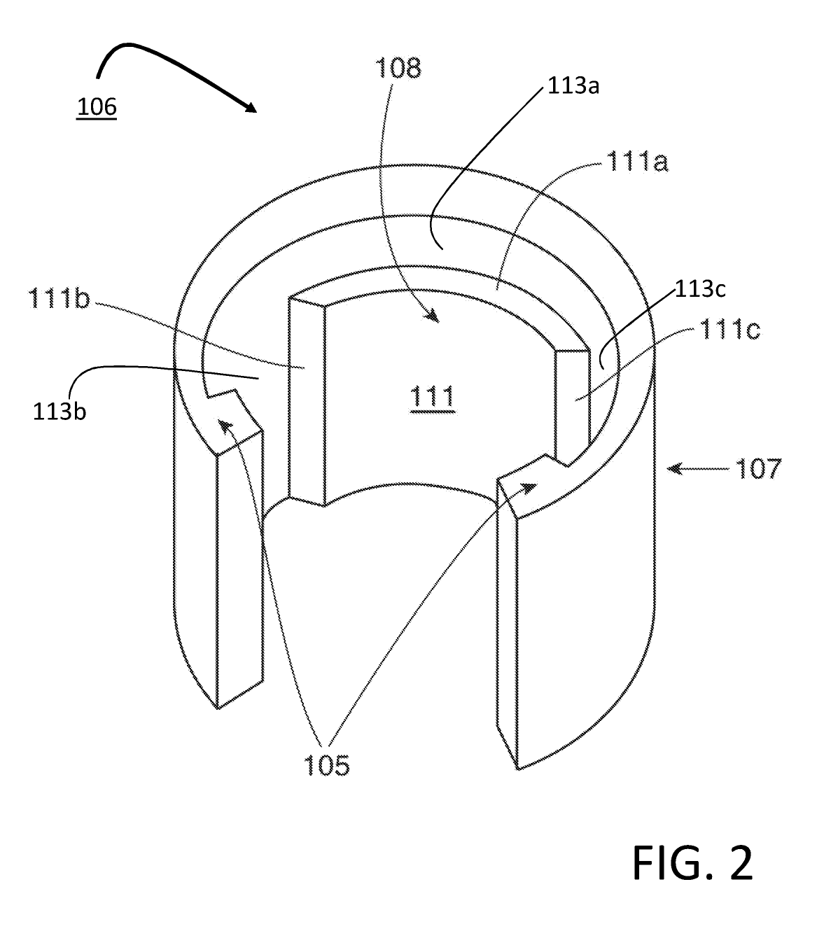

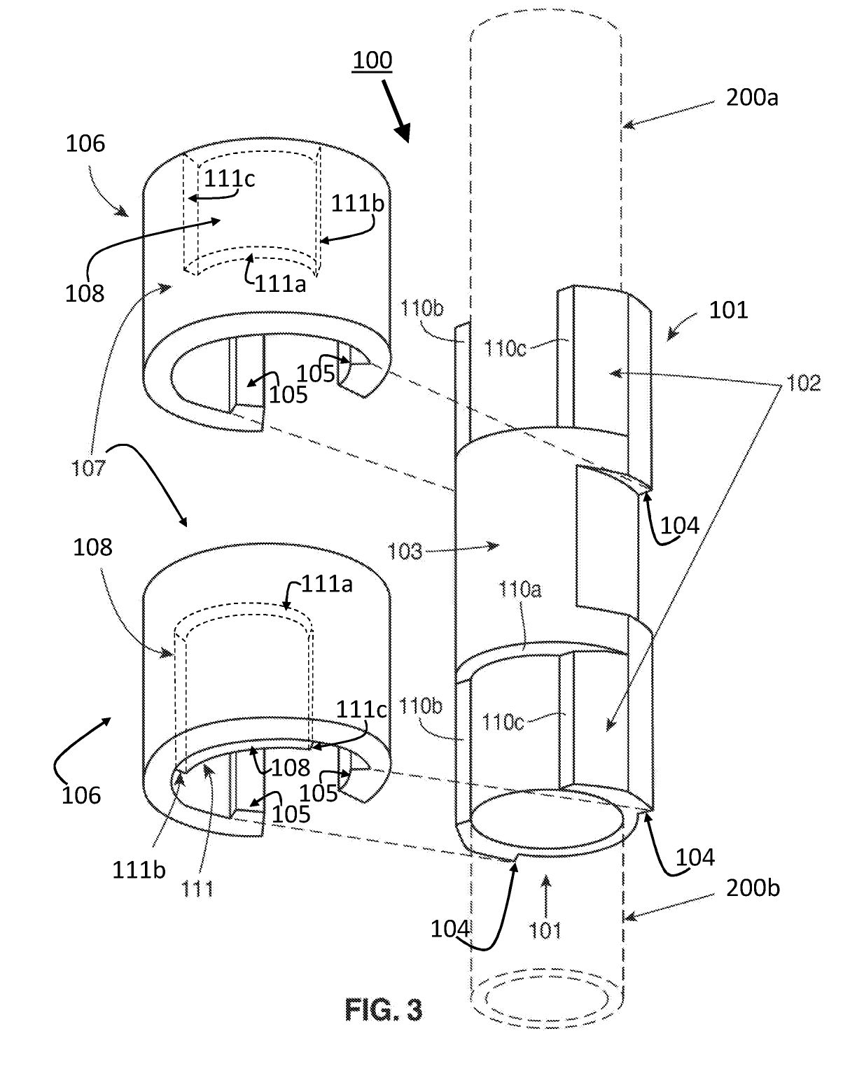

The drawing figures provide several views of alternative example snap fitting or snap fittings of one or more fitting devices for joining pipes and rods. In an example, the snap fitting portion is of a pipe joint or joining device, system or method hereof is a portion which may include one or more snap collar subsystems and may, but not necessarily, also include a connecting architecture subsystem, attached to or configured for attachment of pipes (note, no pipes are shown in FIG. 1 or 2, inter alia, below, but, starting with FIG. 3, etc., one or more pipes are shown typically in dashed line format using a reference numeral 200).

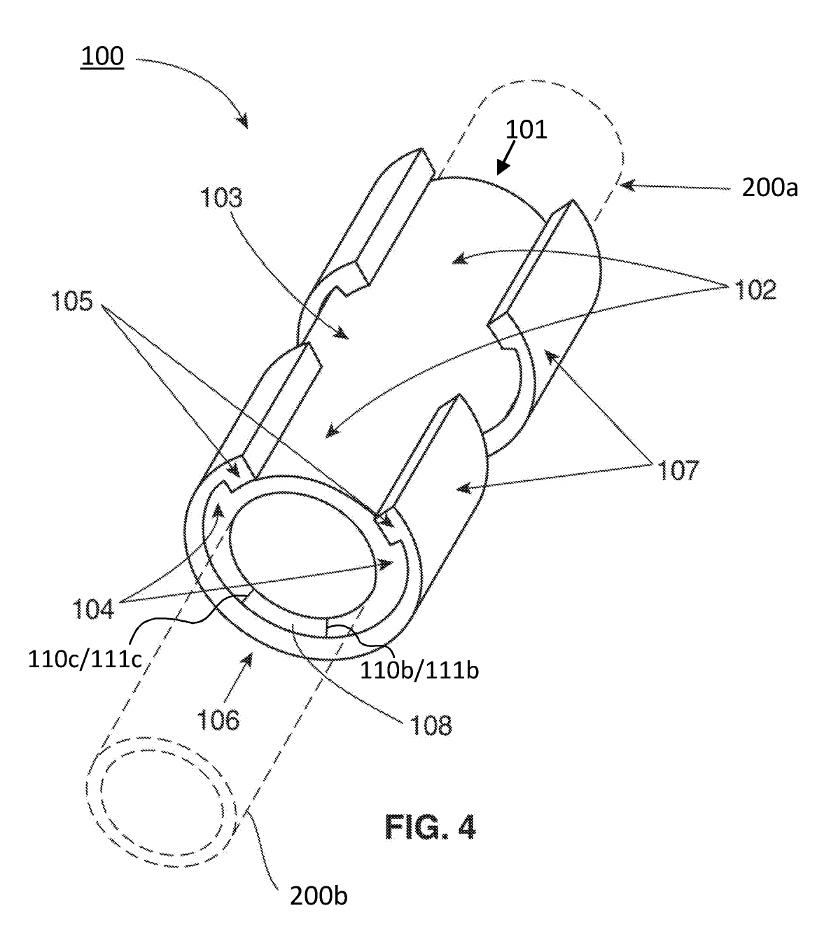

In more particularity for an exemplar first implementation; FIGS. 1 and 2 show respective parts portions of a snap fitting combination 100 (element 100 is not shown in FIGS. 1 and 2, but, see FIGS. 3 and 4, described below). The portions of the overall device 100 are a snap portion 101 as shown separately in FIG. 1 and a lock portion 106 as shown in FIG. 2. FIG. 3 shows an exploded view of the portions 101 and 106 (two such portions 106 in FIG. 3) being brought together relative to two pipe portions 200a and 200b. FIG. 4 shows the assembled combination fitting device 100 formed of/from portions 101 and 106.

In still further particularity, in FIG. 1, a connecting architecture subsystem 103 is shown with two respective snap collars 102 on and connected to/at each end of the subsystem 103. Each snap collar 102 is substantially shaped as a hollow cylindrical arc sweeping out more than 180 degrees (but typically less than 360 degrees) such that it can snap over the cylindrical shape of the pipe by a motion that is substantially perpendicular to the longitudinal axis of pipe (connection to a pipe is not shown in FIG. 1, but, see FIGS. 3 and 4, described further below). After snapping into place, the snap collars 102 will hold the pipe and provide friction and pressure to the plumbing joint as it mates to the mating or sealing surfaces generally identified by reference numerals 110, et al. (which will be described more below).

Also shown in FIG. 1 are a variety of surfaces against which engagement is configured to occur. For a first example, the substantially semi-circular face or sealing 110 is shown as this would engage the outer surface of the pipe, but also shown are the circular end portion 110a of connecting architecture 103 which is configured to engage the end of the pipe as well as at least a portion of lock 106. Moreover, introduced are edges 110b and 110c and surfaces 112a, 112b and 112c which will engage particular surfaces of lock portion 106 as described below. Lastly, FIG. 1 shows a nest 104 that will also engage a corresponding part of lock portion 106 as described below.

Shown in more particularity in FIG. 2 is the lock portion 106 of overall combination fitting device 100. Lock 106 includes a lock collar 107 which cooperates with and co-acts with connecting architecture subsystem 103 and a respective snap collar 102 of FIG. 1, as described further below. Also shown are hooks 105 and a seal protrusion 108. Seal 108 is shown in most particularity in FIG. 2 (but, see also FIGS. 3, 4, 5, 7 and 10). The shape of the seal protrusion 108 is such that it fits like a cork into the mating surfaces on the snap collar 102 to form a continuous pressure tight fit between the snap lock fitting 100 and the pipe 200. Collar 102 defines an open area of pipe into which the protrusion 108 is configured to fit. This pressure tight fit due to 3-D shape of protrusion 108 and the corresponding engaging surfaces of snap collar 102 increases in effectiveness as the pressure exerted by the hook and nest in the locking mechanism increases (not hook and nest engagement described below). Also shown in FIG. 2 are surfaces 111, 111a, 111b and 111c of seal protrusion 108, as well as surfaces 113a, 113b and 113c. Surface 111 engages the pipe, where surface edge 111a engages corresponding semicircular surface 110a of connecting architecture 103 and surface edges 111b and 111c engage corresponding edges 110b and 110c of collars 102 (note, suffixes “b” and “c” are relatively arbitrary and do not require engagement in kind—a “b” element can engage either a “b” or a “c” depending upon the circumstances). Further surfaces 113a, 113b and 113 c of lock portion 106 are configured to engage relative portions 112a, 112b and 112c of collar portions 102.

In one or more examples, various adhesives, sealants, fillers, tapes, and gaskets may also be incorporated to hold and seal in place a pipe 100 on the sealing surface or surfaces 110 and/or 111, 112 and/or 113 (and or suffixed sub-parts “a”; “b”; or “c” thereof) of the snap collar 102 and lock collar 107, although this is not required. As introduced briefly above, in one or more examples, the snap collar subsystem 102 is configured to incorporate one or more nests 104 as shown in FIG. 1, et al., into which corresponding hooks 105, see FIG. 2 et al., of a lock collar 107 may engage and/or attach, see FIGS. 3 and 4, et al.

Before continuing, it should be noted that the examples described above are provided for purposes of illustration, and are not intended to be limiting. Other devices and/or device configurations may be utilized to carry out the operations described herein.

FIG. 2 is an isometric view of an example lock collar 107 of the fitting device for joining pipes and rods. In an example, the lock collar 107 is substantially shaped as a hollow cylindrical arc that may sweep out more than 180 degrees such that it will snap over the substantially cylindrical shape of the snap collar 102, and the pipe 100. The sealing surfaces 111 and 113 (and suffixed sub-parts a, b and/or c thereof) mate with the corresponding sealing surfaces 110 and 112 (and suffixed sub-parts a, b and/or c thereof) on the snap collar 102 and on the pipe 200 and/or 200a and/or 200b. Note, surfaces 110 and 111 engage and seal the circumference of the pipe. The other surfaces engage one another parts of the device 100.

FIG. 3 is an exploded isometric view of an example snap lock fitting device 100 for joining pipes and rods; device 100 being the combination of sub-parts 101 and 106 from FIGS. 1 and 2, as described above. The example overall snap lock fitting or fitting device 100 is a pipe joint comprising one or more or here two lock collars 107 attached over each of the snap collars 102 of the snap fitting combination 100. As in FIG. 1, the snap fitting portion 101 includes one or more snap collar 102 that join one or more pipes 200, here 200a and 200b to a connecting architecture 103. Each of the lock collars 107 provides hooks 105 that attach to the nests 104 in the snap collars. In an example, the nests and hooks lock the lock collars in place, cover and seal the attached pipe and snap collars, and provide additional pressure to the plumbing joint, beyond what is provided by the snap fitting 100 by itself.

In one or more examples, various adhesives, sealants, fillers, tapes, and gaskets that are known may also be incorporated to hold and seal the lock collar in place, although this is not required.

In one or more examples, the fitting device lock collar 107 forms a pressure seal, and presents a relatively smooth surface, and avoids the need to move the pipes or fittings along the direction of the longitudinal axis of the pipe 200 or pipe portions 200a, 200b in order to connect them. Instead, a lateral movement first snaps the pipe in place using the snap fitting portion 101, and then locks the snap fitting 100 together using the lock fitting portion 106, avoiding the difficulties described above.

In one or more examples the fitting device 100 for joining pipes and rods allows the repair of pipe using any shape of fitting, and reduces the size of the access needed for repairs and therefore limits and reduces the time and costs associated with gaining the access.

During an example construction operation, a pipe 200 may need to be iteratively moved along its longitudinal axis, which may exacerbate difficulties, escalate costs, and slow down the pipe fitting process. However, the fitting device 100 for joining pipes and rods allows dry fitting by using only a snap fitting collar portion 102 with overlaying lock collar 107 of the complete fitting device 100. The snap fitting can easily and quickly be snapped onto pipes, then removed, reoriented, and snapped back on, saving time and reducing the difficulties associated with pipe fitting and repair.

In an example, as the lock collar 107 snaps into place through a motion perpendicular to the longitudinal axis of the pipe 200, hooks 105 on the lock collar 107 fit into nests 104 on the snap collar 102, completing the fitting and mating the overlapping and sealing surfaces.

In an example, various adhesives, solders, sealants, fillers, tapes, and gaskets that are known or as may yet reasonably be to be developed may also be incorporated to hold and seal the lock collar in place, although this is not required.

FIG. 4 is an isometric view of an example snap fitting completion of the end assembled fitting device 100 for joining pipes and rods. In an example the snap collar subsystem 102 is substantially shaped as a hollow cylindrical arc that sweeps out more than 180 degrees such that it will snap over the cylindrical shape of the pipe 200, or respective portion 200a, or 200b.

In an example, the snap collar subsystem 102 snaps over the pipe 200, or respective portion 200a, or 200b holding the pipe in place adjacent to the connecting architecture 103.

In an example, various adhesives, solders, sealants, fillers, tapes, and gaskets that are known or as may reasonably yet be developed may also be incorporated to hold and seal the snap collar subsystem on the pipe, although this is not a requirement.

In one or more examples, the lock fitting device or portion 106 forms a pressure seal, and presents a relatively smooth surface or surfaces 111 and/or 113 (with or without suffixed appurtenant parts a, b and/or c), and avoids the need to move the pipes or fittings along the direction of the longitudinal axis of the pipe 200, or respective portion 200a, or 200b in order to connect them. Instead, a lateral movement first snaps the pipe in place using the snap fitting 100, and then locks the snap fitting portion 101 together using the lock fitting portion 106, avoiding the difficulties described above.

In an example the fitting device 100 for joining pipes and rods allows the repair of pipe using any shape of fitting, and reduces the size of the access needed for repairs and therefore limits and reduces the time and costs associated with gaining the access.

During an example construction operation, a pipe 200, or respective portion 200a, and/or 200b may need to be iteratively moved along its longitudinal axis, which may exacerbate difficulties, escalate costs, and slow down the pipe fitting process. However, the fitting device 100 for joining pipes and rods allows dry fitting by using only a snap fitting portion 101 portion of the complete fitting device. The snap fitting can easily and quickly be snapped onto pipes, then removed, reoriented, and snapped back on, saving time and reducing the difficulties associated with pipe fitting and repair.

In addition, if a pipe is misaligned during a standard construction, fitting, or repair process, parts may need to be cut out and replaced. This may introduce additional difficulties, escalate costs, and further slowdown the pipe fitting process. In an example, the fitting device for joining pipes and rods allows for a snap fitting to be bonded to pipes without moving the pipes. This may further avoid improper alignment of the pipes.

Furthermore, though perhaps more applicable in other implementations as shown for example in FIG. 10, described further below, or otherwise not shown, for the repair of a conduit that contains a wire, fiber optic cable, or other type of strand, the repair may need to be accomplished without cutting the strand. In an example, the fitting device for joining pipes and rods can be configured as a coupling without any connecting architecture, such that one or more snap collars and one or more lock collars are assembled into a straight coupling or a sweeping bend around the conduit without cutting the strand.

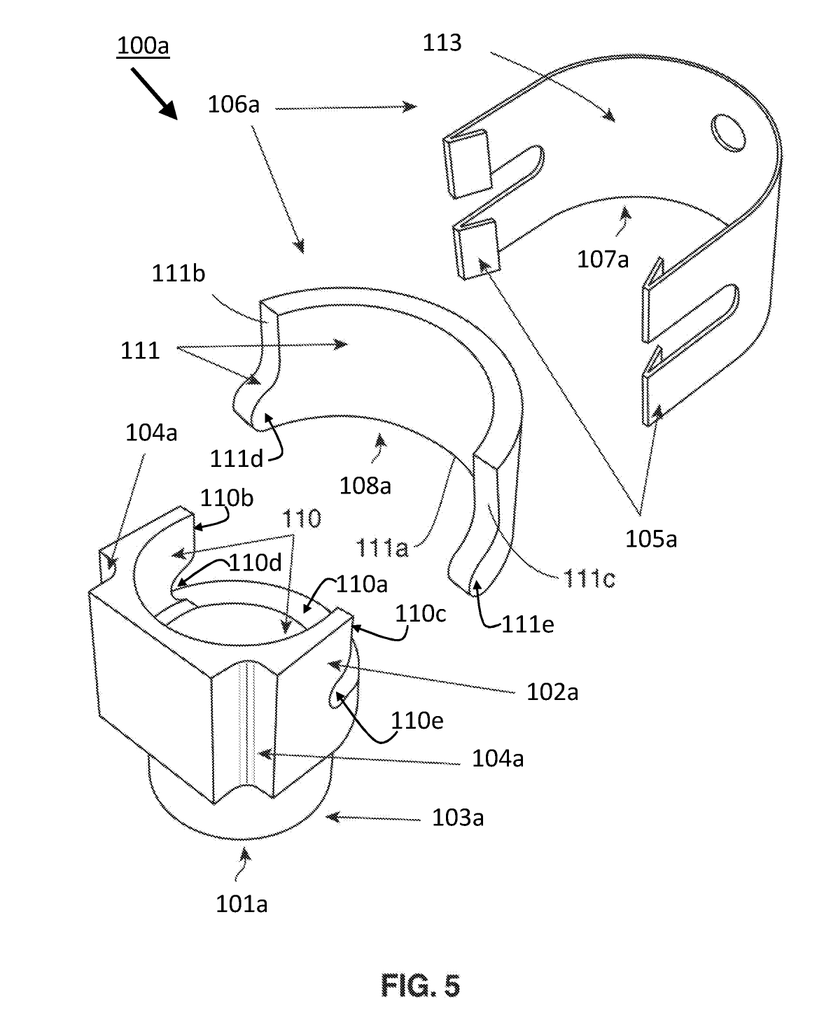

In an alternative, FIG. 5 is an exploded isometric view of an example fitting device 100a for joining pipes and rods. In an example, the snap fitting portion 101a, and the lock collar portion 106a are configured to connect with a somewhat discretely disposed lock collar seal subsystem 108a, which is herein still identified as part of portion 106a, though in some cases discrete therefrom. The lock collar portion 106a includes a lock collar lock subsystem 107a are shown in position to be assembled through a force perpendicular to the longitudinal axis of the fitting device 100a.

In one or more examples of the implementation of FIG. 5, the snap fitting device 100a is configured of or from the snap collar subsystem 102a and a connecting architecture subsystem 103 a street fitting known or to be developed for accepting or connecting to pipes (not shown in FIG. 5). The snap collar subsystem 102a is substantially shaped as a hollow cylindrical arc that sweeps out more than 180 degrees such that it will snap over the cylindrical shape of a pipe or rod and includes nests 104a for the hooks 105a of the lock collar subsystem 107a to snap onto.

In an example, the lock collar 106a is configured of/from the lock collar seal subsystem 108a and the lock collar lock subsystem 107a shown in an exploded view in FIG. 5. Seal 108a is shown in FIG. 5 with some slight variations over that of prior described seal 108 of FIGS. 1-4. First, as noted, it is configured separately from but coacts with collar 107a. The shapes of the seal surface 110 and corresponding relative surfaces or edges 110a, 110b, 110c are such that they fit with corresponding shape of seal protrusion 108a of FIG. 5 with protrusion 108a fitting like a cork into and/or against the mating surfaces 110, 110a, 110b, 110c on the snap collar 102a to form a continuous pressure tight fit between the snap lock fitting 100a and the pipe (not shown in FIG. 5). Collar 102a defines an open area of pipe into which the protrusion 108a is configured to fit. Moreover, this pressure tight fit due to 3-D shape of protrusion 108a and the corresponding engaging surfaces of snap collar 102a increases in effectiveness as the pressure exerted by the hook and nest in the locking mechanism increases (not hook and nest engagement described below). Also shown in FIG. 5 are surfaces 111, 111a, 111b and 111c of seal protrusion 108, as well as surface 113 of collar 107a. Surface 111 engages the semi-circular outer surface of the pipe, where surface edge 111a engages corresponding semicircular surface 110a of collar 102a and surface edges 111b and 111c engage corresponding edges 110b and 110c of collar 102a (note, suffixes “b” and “c” are relatively arbitrary and do not require engagement in kind—a “b” element can engage either a “b” or a “c” depending upon the circumstances). Further shown are protrusion surfaces 111d and 111e on each side of seal portion 108a which are configured to fit into and engage relative correspondingly formed depression surfaces 110d and 110e on each side of collar portion 102a. Note, surfaces 110 and 111 engage and seal the circumference of the pipe. The other surfaces engage one another parts of the device 100.

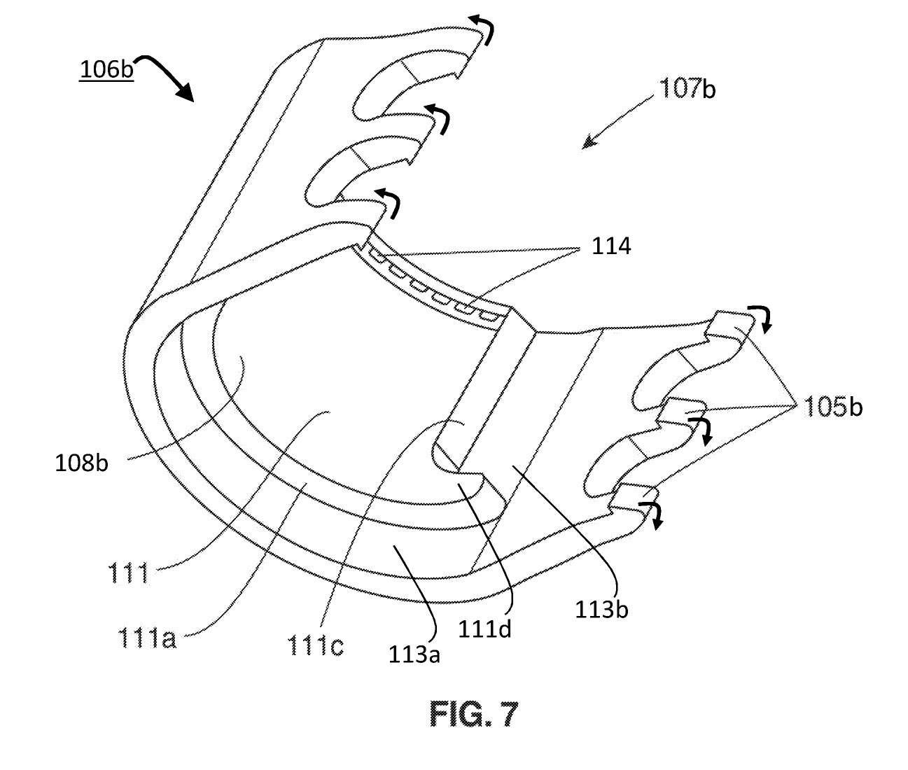

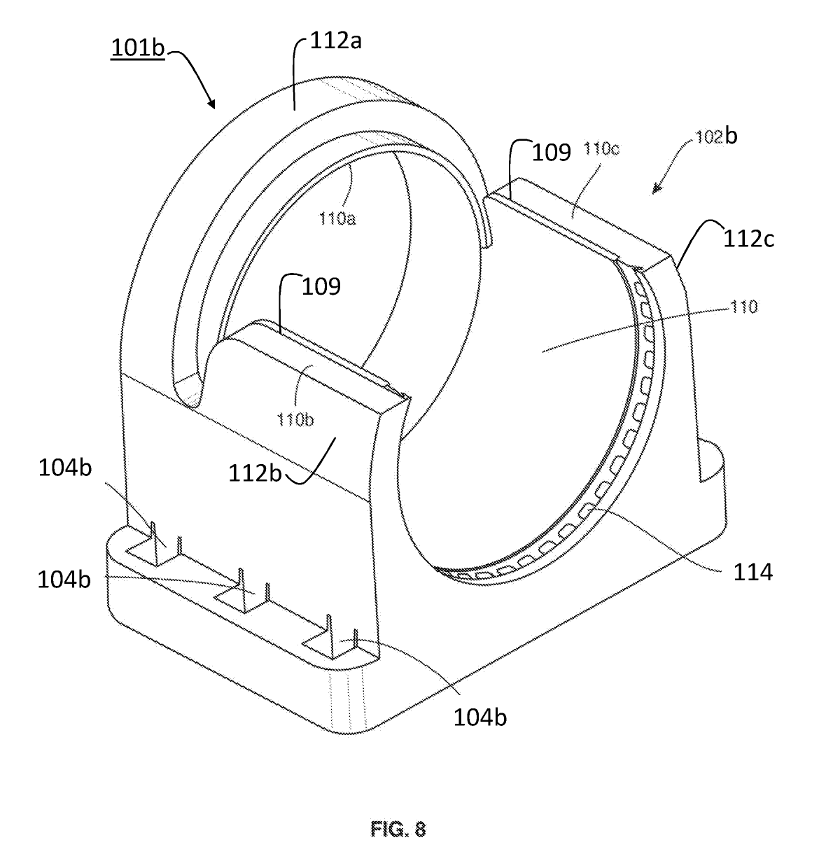

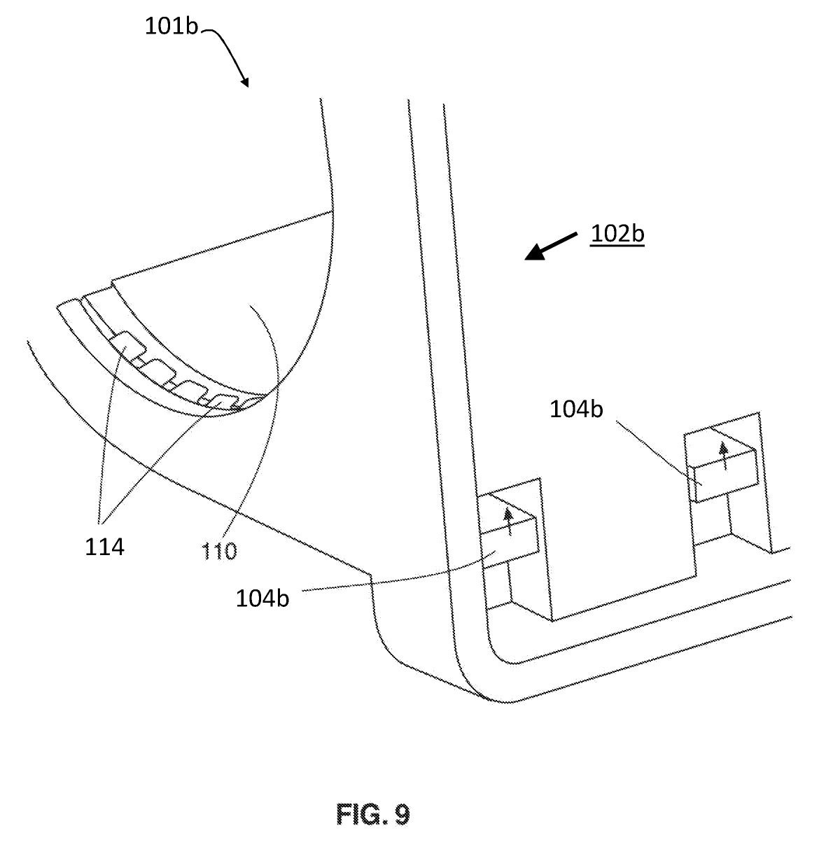

FIG. 6 is an isometric view of three alternative example snap fitting portions 101b for use with various pipe. Here also, these may be with or without the need of cement or other adhesive. The present example of FIG. 6 includes variations of collar 102b, nest 104, seal 110, and not before herein shown or described anti thrust 114 subsystems. The shapes of the seal surface 110 and corresponding relative surfaces or edges 110a, 110b, 110c are such that they fit with corresponding seal protrusion 108b of FIG. 7, see below, with protrusion 108b fitting like a cork into and/or against the mating surfaces 110, 110a, 110b, 110c on the snap collar 102b to form a continuous pressure tight fit between the snap lock fitting or fittings 101b and the pipe (not shown in FIGS. 6-9). I.e., as before or at least in a similar fashion, collars 102b define respective open areas of pipe into which the protrusions 108b (FIG. 7) of locks 106b (FIG. 7) are configured to fit. This pressure tight fit due to 3-D shape of protrusion 108b and the corresponding engaging surfaces of snap collar 102b increases in effectiveness as the pressure exerted by the hook and nest in the locking mechanism increases (not hook and nest engagement described below). Note, FIGS. 8 and 9 are not unlike and yet includes only one separate snap portion 101b; the other parts hereof (see e.g., 102b, 104b, 110, 110a, 110b, 110c and 114) remaining substantially the same or similar. Interaction of part 106b of FIG. 7 will be described relative to all three of FIGS. 6, 8 and 9, which may be interchangeably understood as well.

Also shown in FIG. 7 particularly relative to protrusion 108b are surfaces 111, 111a, and 111c (111b unfortunately hidden here) of seal protrusion 108b, as well as surfaces 113a and 113b (surface 113c hidden here) of collar 107b. Surface 111 engages the semi-circular outer surface of the pipe, where surface edge 111a engages corresponding semicircular surface 110a of collar 102b (FIGS. 6, 8 and 9) and surface edges 111b and 111c engage corresponding edges 110b and 110c of collar 102b (note, suffixes “b” and “c” for surfaces 110 and 111 and 112 and 113 are relatively arbitrary and do not require engagement in kind—a “b” element can engage either a “b” or a “c” depending upon the circumstances). Further shown are protrusion surfaces 111d (111e hidden) on each side of seal portion 108a which are configured to fit into and engage relative correspondingly formed depression surfaces 110d and 110e on each side of respective collar portions 102b. Note, surfaces 110 and 111 engage and seal the circumference of the pipe. The other surfaces engage one another parts of the device 100.

Returning to description of FIG. 6 for a moment, the present example uses what may in many implementations be every subsystem that may desirably be part of the snap fitting of the fitting device 101b for fitting pipes. Theses subsystems are the three snap collars 102b, nests 104b, seal 110, 110a, 110b, 110c, 112a, 112b, 112c, anti-thrust 114, and the connecting architecture 103b, a tee in the present example. The snap collars 102b are aligned on the connecting architecture 103b such that the “A” snap collar 102b can be snapped into place first in a longitudinal motion along the longitudinal axis of B and C collars, and the entire snap fitting 101b can be rotated to snap in the “B” and “C” snap collars 102b; the rotation can be about the longitudinal axis of the A collar—in one or more implementations of such, the opposing dispositions of the B and C collars 102b can provide for a single substantially simultaneous (similar in time but not necessarily absolutely identically timed) snap in connections to respective pipe portions for each of the B and C collars. This also demonstrates that in discrete implementations, the snap collars 102b and the connecting architecture 103b may be configured in various ways.

In an example, the snap collars 102, 102a, 102b etc., have a sealing surface 110 made of a soft gasket type of or other type of sealing material; and may be a different material than the respective collars 102, 102a, 102b, etc. The use of a separate material as an inner lining for seal surface 110 is shown best by the connection lines 109 in FIG. 8 (also shown in FIG. 6, but less clearly). This example configuration may be specifically used for joining pipes without glues or adhesives. Protrusion devices 108, 108a, 108b etc may similarly be of different sealing material than the corresponding collar 107, 107a, 107b etc. The snap collars are also shown in this example and has an anti-thrust subsystem 114, and active nests 104, 104a, 104b etc. The anti thrust subsystem 114 is configured in the present example by using a thin, stiff, and springy material that will bite into the pipe and hold it against outward thrust due to pressure inside the pipe and fitting device. The anti thrust subsystem 114 on the lock collar 107b is similar to the same on the snap fitting 101b.

FIG. 7 is an isometric view of an example lock portion 106b with lock collar 107b. In an example, the snap collar of FIG. 7 has a sealing surface 111 (with sub-parts 111a, 111b, 111c and 111d), 113 (with sub-parts 113a and 113b), seal 108b hooks 105b, and anti-thrust 114 subsystems with a continuous 3-D sealing surface. The shape of the seal 108b is such that it fits like a cork into the mating surfaces on the snap collar 102b to form a continuous pressure tight fit between the snap lock fitting and the pipe 200 (not shown in FIGS. 6-9). This pressure tight fit due to 3-D shape increases in effectiveness as the pressure exerted by the hook and nest in the locking mechanism increases. The anti thrust subsystem 114 on the Lock Collar 107b is similar to the analogous subsystem on the snap fitting 101b. Note, surfaces 110 and 111 engage and seal the circumference of the pipe. The other surfaces engage one another parts of the device 100.

FIG. 8 is an isometric view of an example snap portion 101b including a snap collar subsystem 102b. The present example has nest 104b, seal 110, 112, and anti thrust 114 subsystems. The nest subsystem is configured such that the nests 104b in the present example are embedded in holes that provide a method to securely hold the hook subsystem 105b (shown in FIG. 7) of the lock collar. To insert the hooks 105b into the nests 104b the hooks 105b flex outward (see FIG. 7) as they clear the body of the snap collar 102b. As the fitting is pushed together the hooks 105b insert into the holes where the hooks 105b begin to flex back inward and cause the nests 104b to flex inward also (this is shown by the motion arrows for nests 104b in FIG. 9). Upon mating the nests 104b snap back under the hooks 105b and the fitting is complete. The seal subsystem 110 is configured with a gasket material such that the seal is accomplished without the need of cement or adhesive. The anti thrust subsystem 114 is configured in the present example by using a thin, stiff, and springy material that will bite into the pipe and hold it against outward thrust due to pressure inside the pipe and fitting device.

FIG. 9 is an isometric view of an example snap collar 102b shown from the bottom of 102b showing detail of the nests 104b. The present example shows one configuration of the nests 104b where the hooks fit inside a hole such that once the hooks 105b are snapped into place the holes 104b keep the hooks 105b from slipping back off the nests 104b. The arrows show how the nests 104b flex when the hooks 105b are snapped into place. The seal 110 and the anti thrust subsystem 114 are also shown.

FIG. 10 is an exploded isometric view of an example snap portion 101c and lock portion 106c used to repair an existing pipe 200 either by itself or in some implementations without disturbing any material, strand, fluid, vacuum or other contained within the pipe. The snap portion 101c has a snap collar 102c that snaps onto a pipe 200. An interior sealing surface 110 as this would engage the outer surface of the pipe is shown, as are 110b and 110c (110a would typically not appear in this version). Any of the alternative implementations involving sealing surfaces may be applicable here as well. Exterior surfaces 112b and 112c are also shown as these would/could be used here (112a would typically not appear here). The lock portion 106c as it would include a lock collar 107c, sealing protrusion 108c and hooks 105c are shown in position to be assembled. In the present example, the snap fitting 101c has a snap collar subsystem 102c, and the nest subsystem 104c. The lock collar portion 106c has a lock collar subsystem 107c, a seal subsystem 111, with sub-surfaces 111b and 111c and 113b and 113c, and the hook subsystem 105c. Surfaces 110 and 111 engage the pipe. In the present example, the pipe 200 is shown as a transparent pipe 200 with an irregular hole 115 to be repaired. The hole 115 would be covered over with one or the other or both of snap collar 102c and lock collar 107c and be sealed shut thereby. Note, surfaces 110 and 111 engage and seal the circumference of the pipe. The other surfaces engage one another parts of the device 100. E.g., Surfaces 110b and 111b may engage and 110c and 111c may engage, to complete the sealing of the connection. Surface 112b may engage surface 113b and surfaces 112c and 113c may engage.

In some other examples, and alternative disposition of nests and hooks may be presented. FIG. 11 shows where the lock collar can alternately be configured with a nest subsystem and the snap collar can be configured with the hook subsystem. In this example as the lock collar snaps into place through a motion perpendicular to the longitudinal axis of the pipe, the hooks on the snap collar fit into the nests on the lock collar, completing the fitting and mating of the overlapping and sealing surfaces. FIG. 11 is an exploded isometric view of an example snap fitting 101d, pipe 200 and lock collar 106d that demonstrates the hook 105d and nest 104d subsystems may be associated with either the respective snap collar 102d or the lock collar 107d. In the present example, the snap fitting 101d is made of the snap collar 102d and hook 105d subsystems while the lock collar 107d is made of the nest 104d subsystem. Both the snap collar 102d and the lock collar 107d have respective continuous sealing surfaces 110, 111 that mate with the pipe and corresponding collar. Note, surfaces 110 and 111 engage and seal the circumference of the pipe. The other surfaces engage one another parts of the device 100d.

Furthermore, for the repair of a conduit that contains a wire, fiber optic cable, or other type of strand, the repair may need to be accomplished without cutting the strand. In an example, the fitting device for joining pipes and rods can be configured as a coupling without any connecting architecture, such that one or more snap collars and one or more lock collars are assembled into a straight coupling or a sweeping bend around the conduit without cutting the strand.

The components, arrangements, and operations shown and described herein are provided to illustrate example implementations. It is noted that the operations are not limited to the ordering shown. Still other operations, arrangements, and components may also be implemented to achieve a desired effect. For example, the components may work with or be configured to work with threaded pipes and unthreaded connecting architecture, or with unthreaded pipes and threaded connecting architecture, or with pipes and connecting architecture of mismatched size or shape. The connecting architecture could come in two or more pieces, and could itself be held together using snap collars and lock collar, and may form a lock fitting comprised of two or more lock collar subsystems and a connecting architecture. These and other variations will be readily appreciated by those having ordinary skill in the art after becoming familiar with the teachings herein.

It is noted that the examples shown and described are provided for purposes of illustration and are not intended to be limiting. Still other examples are also contemplated.

1. A method of joining pipes, comprising:
positioning two pipes adjacent to one another along their longitudinal axes;
snapping a respective snap collar onto both of the pipes such that each snap collar covers the ends of both pipes; and
snapping a lock collar onto the snap collar such that the pipes are joined, the lock collar having a sealing protrusion to seal the connection of the snap collar and lock collar on the pipe.

2. The method of claim 1, further comprising adding any of an adhesive, solder, sealant, filler, tape, or gasket between any two or more pipes, snap collars, and lock collars, to strengthen and/or seal the joint.

3. The method of claim 1, further comprising providing snap collars and/or lock collars that, by their shape, dimensions, materials, and/or manufacturing tolerances, create enough friction and inward pressure on the pipe or pipes to secure or seal the joint without the need for adhesives, solders, sealants, fillers, tapes or gaskets

4. The method of claim 1, the pipe being a conduit containing a wire, cable, or other strand, and the joint is made without severing the wire, cable, or other strand.

5. The method of claim 1, a single pipe being repaired without cutting the pipe.

6. The method of claim 1, one or more of:
the sealing protrusion of the lock collar having one or more sealing protrusions to engage corresponding depressions in the snap collar to seal the connection of the snap collar and lock collar on the pipe; and,
the snap collar having one or more external surfaces and the lock collar having one or more corresponding internal surfaces to be engaged with or by the one or more external surfaces of the snap collar to seal the connection of the snap collar to the lock collar.

7. A method of joining pipes, comprising:
positioning one or more pipes into a geometry that is an extension of the connecting architecture subsystem, such that the connecting architecture fit on the ends of each pipe, forming a joint, bend, intersection, adapter or street fitting;
snapping one snap collar subsystem over each pipe end that is adjacent to the connecting architecture subsystem such that the pipes are securely held into the connecting architecture subsystem by the snap collar subsystem; and
snapping one lock collar over each of the snap collar subsystems, such that the snap collar subsystems are held in place are covered and sealed by the lock collars, the lock collar having a sealing protrusion to seal the connection of the snap collar and lock collar on the pipe thus securing the joint.

8. The method of claim 7, further comprising adding any of an adhesive, solder, sealant, or filler between any two or more pipes, connection architectures, snap collars, and lock collars, in order to strengthen and/or seal the connection.

9. The method of claim 7, further comprising one or more of:
providing snap collars and/or lock collars that, by their shape, dimensions, materials, and manufacturing tolerances, create enough friction and inward pressure on the pipe or pipes to secure or seal the joint without the need for adhesives, solders, sealants, fillers, tapes or gaskets;
the sealing protrusion of the lock collar having one or more sealing protrusions to engage corresponding depressions in the snap collar to seal the connection of the snap collar and lock collar on the pipe; and,
the snap collar having one or more external surfaces and the lock collar having one or more corresponding internal surfaces to be engaged with or by the one or more external surfaces of the snap collar to seal the connection of the snap collar to the lock collar.

10. The method of claim 7, further comprising providing a connecting architecture that assembles from two or more pieces and is itself held together with one or more snap collars and one or more lock collars, either with or without adhesives, solders, sealants, fillers, tapes, or gaskets.

11. A fitting device for joining pipes or rods, comprising:
one or more snap collars; and
one or more lock collars, the lock collar having a sealing protrusion to seal the connection of the snap collar and lock collar on the pipe;
the one or more snap collars being configured to be snapped in place over a pipe, and the lock collars being configured to be snapped in place over the pipe and the snap fittings, the sealing protrusion engaging the pipe to seal the connection of the snap collar and lock collar on the pipe so that a sealed joint will be formed.

12. The fitting device of claim 11, the pipe being a conduit having one or more wires, cables, or strands, and a joint is formed without severing the wires, cables, or strands.

13. The fitting device of claim 11, one or more of:
the sealing protrusion of the lock collar having one or more sealing protrusions to engage corresponding depressions in the snap collar to seal the connection of the snap collar and lock collar on the pipe; and,
the snap collar having one or more external surfaces and the lock collar having one or more corresponding internal surfaces to be engaged with or by the one or more external surfaces of the snap collar to seal the connection of the snap collar to the lock collar.

14. The fitting device of claim 11; further comprising a connecting architecture, such that the ends of the two or more pipes are placed into the connecting architecture rather than end-to-end against one another, and the fitting device secures the pipes in the connecting architecture, forming a joint, bend, or intersection.

15. The fitting device of claim 14, further comprising any of an adhesive, solder, sealant, filler, tape or gasket placed between one or more pipes, connecting architectures, snap collars, and lock collars, to strengthen and/or seal the connection.

16. The fitting device of claim 14, the snap collars and/or lock collars that, by their shape, dimensions, materials, and manufacturing tolerances, creating enough friction and inward pressure on the pipe or pipes to secure or seal the joint without the need for adhesives, solders, sealants, fillers, tapes or gaskets.

17. The fitting device of claim 14, further comprising a multi-part connecting architecture that is itself held together with one or more snap collars and one or more lock collars, or with a lock fitting comprised of lock collar subsystems and connecting architecture subsystem, with or without adhesives, solders, sealants, fillers tapes, or gaskets.

18. The fitting device of claim 14, the connecting architecture being an intersection that is attached to a middle section of a rod without severing the rod.

19. The fitting device of claim 14, the fitting device being configured to be employed to repair a conduit containing one or more wires, cables, fibers or strands, without severing the wires, cables, fibers or strands.

20. The fitting device of claim 16, the lock collars being made of two separate subsystems, a lock collar seal subsystem and a lock collar lock subsystem, made of differing materials and manufacturing tolerances.
